(19) United States
(12) Patent Application Publication
(10) Pub. No.: US 2011/0239034 A1
(43) Pub. Date: Sep. 29, 2011

(54) TRANSMISSION APPARATUS AND CONTROL METHOD

(75) Inventor: Hayato OKUDA, Kawasaki (JP)

(73) Assignee: FUJITSU LIMITED, Kawasaki-shi (JP)

(21) Appl. No.: 13/039,534

(22) Filed: Mar. 3, 2011

(30) Foreign Application Priority Data
Mar. 29, 2010 (JP) 2010-075947

(51) Int. Cl. G06F 1/04

(52) U.S. Cl. 713/503

(57) ABSTRACT

There is provided a transmission apparatus including: a clock generator; a first circuit including first data processors to process input data based on a first input clock, the first data processors electrically connected in series each transmitting data processed thereby and the first input clock to the next first data processor, the first input clock of the beginning first data processor being one of the clocks generated by the clock generator; a second circuit including: second data processors same as the first data processors; and phase adjusters each to adjust a phase of the second input clock and transmitting the second input clock adjusted thereby to the next second data processor; phase comparators each to compare phases of the first input clock and the second input clock; and a delay controller to control the phase adjusters, based on comparison results of the phase comparators.

### CROSS-REFERENCE TO RELATED APPLICATION

This application is based upon and claims the benefit of priority of the prior Japanese Patent Application No.2010-075947, filed on Mar. 29, 2010, the entire contents of which are incorporated herein by reference.

### FIELD

The embodiments discussed herein are related to a transmission apparatus and a control method of the transmission apparatus.

### BACKGROUND

Information communication technology has made considerable progress and become increasingly popular. High speed information transmission techniques which support information communication systems are increasingly in demand. Regarding transmission apparatuses for transmitting information, it is considered to be necessary to develop a core communication system and a subscriber communication system. Thus, a development of optical transmission apparatuses which deal with high speed signals is now increasingly in demand. Especially, the transmission apparatuses take a major role in, for example, base telephone stations, the Internet communication and telephone network communication. Recently, large-scale transmission apparatuses are being developed to meet the requirements about, for example, an increased amount of information and increased transmission speed.

Large-scale transmission apparatuses may include a plurality of data processing units for processing data received. The data processing units, may be referred to as data processors, use in-device reference clocks for the control of data processing timing. If data is exchanged among other units, the reference clocks are exchanged together with the data. Since no reference clock difference occurs for the control of the data processing among the data processing units, accurate processing can be performed to the data received in each unit. It is desirable that clocks used for the control of data are accurate.

Large-scale transmission apparatuses, which highly reliable is required, include a redundancy configuration to avoid suspension of transmission of information due to, for example, a mechanical failure. An exemplary redundancy configuration includes two data processing units which establish two information transmission paths. In the event of a failure in a currently used transmission path, a switchover to another transmission path is made to continue transmission of information. Hereinafter, a transmission path used normally before the switchover occurs may be referred to as a “working circuit” and a transmission path used after the switchover in the event of a failure may be referred to as a “protection circuit.”

If the reference clocks of the working circuit and the reference clocks of the protection circuit are on different phases, the data processing cannot be continued accurately in the event of switchover from the working circuit to the protection circuit. Thus, severe conditions about the phases of the reference clock may be met to achieve a switchover from the working circuit to the protection circuit without suspension of the service.

However, clock phases may be varied due to characteristics inherent to components, such as cables, a printed circuit board and a buffer integrated circuit (IC) used in the working circuit and the protection circuit. There is also variation in the clock phases that cannot be avoided at the design stage due to changes in temperature and changes over the years. Especially in large-scale transmission apparatuses with longer transmission paths, variation in clock phases may further be increased. It is therefore difficult in large-scale transmission apparatuses to accurately adjust the clock phases of the working circuit and the protection circuit.

Techniques for adjusting differences in clock phases produced due to characteristics inherent to components have been proposed. In particular, the following technique has been proposed: clock phase monitor points are defined at which data is processed; a clock phase difference is monitored at the monitor points and the monitored result is fed back to adjust the clock phases at a point at which the clocks are input (see, for example, Japanese Laid-open Patent Publication No. 2004-229020).

### SUMMARY

According to an aspect of the embodiment, there is provided a transmission apparatus including: a clock generator to generate clocks; a first circuit including a plurality of first data processors to process input data based on a first input clock, the plurality of first data processors electrically connected in series each transmitting data processed thereby and the first input clock to the next first data processor, the first input clock of the beginning first data processor being one of the clocks generated by the clock generator; a second circuit including: a plurality of second data processors to process input data based on a second input clock, the plurality of second data processors electrically connected in series each transmitting data processed thereby to the next second data processor, the second input clock of the beginning second data processor being one of the clocks generated by the clock generator; and a plurality of phase adjusters each to adjust a phase of the second input clock and transmitting the second input clock adjusted thereby to the next second data processor; a plurality of phase comparators each to compare phases of the first input clock transmitted from the first data processor and the second input clock transmitted from the phase adjuster; and a delay controller to control the plurality of phase adjusters, based on comparison results of the plurality of phase comparators.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a transmission apparatus according to a first embodiment;

FIG. 2 is a block diagram of a transmission apparatus according to a second embodiment;

FIG. 3 is a flowchart of an exemplary phase adjustment process;

FIG. 4 is a flowchart of another exemplary phase adjustment process;

FIG. 5 is a timing diagram of a phase adjustment process in the transmission apparatus according to the second embodiment;

FIG. 6A illustrates a state upon startup of a transmission apparatus;

FIG. 6B illustrates a state before stabilization of an oscillator frequency of the transmission apparatus;

FIG. 6C illustrates a state after the stabilization of the clock frequency and the phase adjustment of the transmission apparatus;

FIG. 7 is a timing diagram used for the comparison of time required for the phase adjustment in the second embodiment;

FIG. 8A illustrates a state upon startup of a transmission apparatus;

FIG. 8B illustrates a state after the stabilization of the clock frequency and the phase adjustment of the transmission apparatus; and

FIG. 9 is a timing diagram used for the comparison of time required for the phase adjustment in the second embodiment.

### DESCRIPTION OF EMBODIMENTS

In large-scale transmission systems, even if clock phase monitor points are defined at the final point of the data processing and the clock phases are adjusted at that final point, there is a possibility that variation of phases occurs at any points before the final point. Even if some phase difference monitor points are defined during the data processing using a related art technique, it is still difficult to satisfy clock phase requirements at plural points on the transmission path within the device because the phase adjustment is performed at a point at which the clocks are input.

Hereinafter, embodiments of a transmission apparatus and a method for controlling the transmission apparatus will be described in detail with reference to the drawings. The embodiments of the transmission apparatus and the method for controlling the transmission apparatus are illustrative only and not limiting.

### First Embodiment

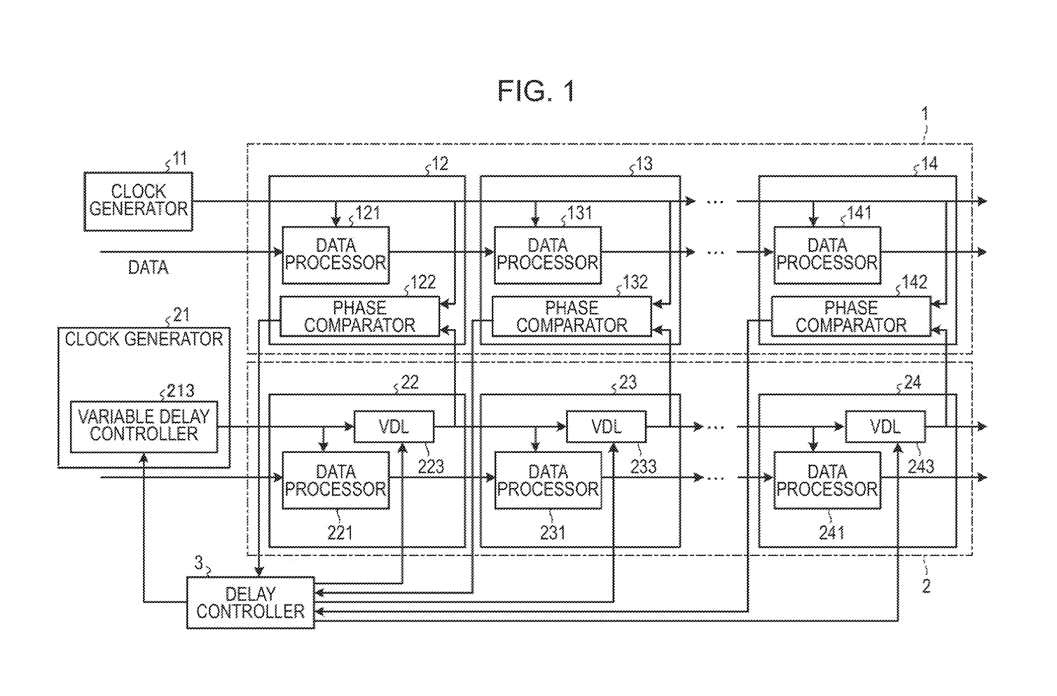

FIG. 1 is a block diagram of a transmission apparatus according to a first embodiment. As illustrated in FIG. 1, the transmission apparatus according to the present embodiment includes two circuits for transmitting data: a first circuit 1 and a second circuit 2. For example, the first circuit 1 is a working circuit and the second circuit 2 is a protection circuit. In particular, for example, the transmission apparatus transmits data over the working circuit, i.e., the first circuit 1, upon startup. In the event of a failure in the first circuit 1, a data transmission path is switched from the first circuit to the second circuit 2, which is then used for the data transmission. The second circuit 2 is normally kept on standby.

The transmission apparatus includes a clock generator 11 which outputs reference clocks to the first circuit 1 and a clock generator 21 which outputs clocks to the second circuit 2. The reference clocks are used for the synchronization of data during data processing. The reference clocks enable accurate data processing among data processor units on the same transmission path.

The clock generator 11 generates reference clocks within the transmission apparatus. Hereinafter, the reference clocks generated by the clock generator 11 may be referred to as “first reference clocks.” The clock generator 11 outputs the reference clocks to a data processor unit 12.

The first circuit 1 has data processor units 12 to 14 disposed therein. For convenience of illustration, the first circuit 1 herein includes three data processor units 12 to 14 as illustrated in FIG. 1; the number of the data processor units is not particularly limited as long as a plurality of data processor units are provided. Although not illustrated in FIG. 1, a plurality of data processing units are disposed between the data processor units 13 and 14 in the present embodiment.

The data processor unit 12 includes a data processor 121 and a phase comparator 122. The data processor 121 receives data input from external devices, such as a mobile station and a server. The data processor 121 executes predetermined processing to the received data and outputs the processed data to the data processor unit 13. In the event of a failure in the first circuit 1, the data processor unit 12 processes the data after the data transmission path is switched to the protection circuit, i.e., the second circuit 2.

The phase comparator 122 acquires the first reference clocks which are output from the clock generator 11 and then input to the data processor unit 13 via the data processor unit 12. The phase comparator 122 acquires the reference clocks which are output from the clock generator 21 of the second circuit 2, which will be described later, and then input to a data processor unit 23 via the data processor unit 22. Hereinafter, the reference clocks output from the clock generator 21 of the second circuit 2 will be referred to as “second reference clocks.” The reference clocks used for the comparison in the phase comparators 122 to 142 in the respective data processor units 12 to 14 will be referred to as “reference clocks in the data processor unit.” For example, the reference clocks used for the comparison in the phase comparator 122 are the first reference clocks in the data processor unit 12 and the second reference clocks in the data processor unit 22. The phase comparator 122 compares the phase of the first reference clocks to the phase of the second reference clocks. The phase comparator 122 then outputs a phase difference between the first reference clocks in the data processor unit 12 and the second reference clocks in the data processor unit 22 to a delay controller 3. The phase comparator 122 may use the first reference clocks for the comparison at any point in the data processor unit 12 as long as the first reference clocks are to be output from the data processor unit 12 to the data processor unit 13. The first reference clocks passes through various components, such as a cable, in the data processor unit 12 at various points. For example, the first reference clocks pass through a first cable at a certain point and pass through the buffer at a certain point. The phase comparator 122 may use the second reference clocks for the comparison at any point in the data processor unit 22 as long as the second reference clocks are to be output from the data processor unit 22 to the data processor unit 23. The first reference clocks and the second reference clocks are in a same stage in the data processor unit 12 and the data processor unit 22. In the present embodiment, the first reference clocks and the second reference clocks in the stage after the data processing in the data processor unit 12 and the data processor unit 22 are used for the acquisition of the phase difference produced in the entire data processor unit 12 and the entire data processor unit 22.

Similarly to the data processor unit 12, the data processor unit 13 includes a data processor 131 and a phase comparator 132 and the data processor unit 14 includes a data processor 141 and a phase comparator 142. The phase comparator 132 outputs a phase difference between the first reference clocks in the data processor unit 13 and the second reference clocks in the data processor unit 23 to the delay controller 3. Similarly, the phase comparator 142 outputs a phase difference between the first reference clocks in the data processor unit 14 and the second reference clocks in the data processor unit 24 to the delay controller 3.

If the data and the reference clocks processed in the data processor unit 14 are to be used in other devices, the data processor unit 14 may output the processed data to an external device together with the reference clocks.

It is also possible to use data processed in data processor units other than the data processor unit 14, e.g., the data processor units 12 and 13, in other devices. In that case, the data processor units 12 and 13 output the data to other devices together with the reference clocks.

The clock generator 21 includes a variable delay controller 213. The clock generator 21 generates the second reference clocks. The variable delay controller 213 is controlled by the delay controller 3 to provide a delay (i.e., a phase difference) to the generated second reference clocks in an amount designated by the delay controller 3. The variable delay controller 213 outputs the second reference clocks provided with the delay to the data processor unit 22. The clock generator 21 is continuously generating the reference clocks in the present embodiment; but the clock generator 21 may alternatively generates the reference clocks only during a phase adjustment in a case in which the phase adjustment is performed only before a service operation. In this case, it suffices that the clock generator 21 starts generating the clocks in response to an instruction through a user interface (not illustrated) from an operator to start the phase adjustment, and stops generating the clocks upon completion of the phase adjustment. For the system operation, however, it is necessary to continuously generate the second reference clocks as in the present embodiment for the continuous data transmission without suspension of the service even if a switchover from the first circuit to the second circuit occurs.

The second circuit 2 includes data processor units 22 to 24. Although the three data processor units 22 to 24 are illustrated in the second circuit 2 as in the first circuit 1, the number of the data processor units is set to be the same as that of the first circuit 1. Although not illustrated in FIG. 1, it is assumed in the present embodiment that as many data processer units are provided between the data processor unit 23 and the data processor unit 24 as in between the data processor unit 13 and the data processor unit 14 in the first circuit 1.

The data processor unit 22 includes a data processor 221 and a variable delay line (VDL) 223. The data processor 221 receives data input from external devices, such as a mobile station and a server. The data processor 221 executes predetermined processing to the received data and outputs the processed data to the data processor unit 13.

The VDL 223 is controlled by the delay controller 3 to provide a delay (i.e., a phase difference) to the second reference clocks in the data processor unit 22 in an amount designated by the delay controller 3. The VDL 223 outputs the second reference clocks to the data processor unit 23. The second reference clocks output from the VDL 223 are partially supplied to the phase comparator 122.

Similarly to the data processor unit 22, the data processor unit 23 includes a data processor 231 and a VDL 233, and the data processor unit 24 includes a data processor 241 and a VDL 243. The data processor units 231 and 241 each execute predetermined data processing. The VDLs 233 and 243 are controlled by the delay controller 3 to provide a delay (i.e., a phase difference) to the second reference clocks. The second reference clocks in the data processor unit 23 are partially supplied to the phase comparator 132. The second reference clocks in the data processor unit 24 are partially supplied to the phase comparator 142. The VDLs 223 to 243 are exemplary phase adjusters.

The delay controller 3 receives, from the phase comparator 122, data of the phase difference between the first reference clocks in the data processor unit 12 and the second reference clocks in the data processor unit 22. The delay controller 3 receives, from the phase comparator 132, data of the phase difference between the first reference clocks in the data processor unit 13 and the second reference clocks in the data processor unit 23. The delay controller 3 receives, from the phase comparator 142, data of the phase difference between the first reference clocks in the data processor unit 14 and the second reference clocks in the data processor unit 24.

The delay controller 3 obtains a delay (i.e., a phase difference) to be provided to the second reference clocks in the variable delay controller 213 and the VDLs 223 to 243 using the phase differences between the data processor units. The delay controller 3 controls the variable delay controller 213 and the VDLs 223 to 243 such that each of the variable delay controller 213 and the VDLs 223 to 243 is provided with a delay in the determined amount.

The present embodiment includes the clock generator 11 which outputs the clocks to the first circuit 1 and the clock generator 21 which outputs the clocks to the second circuit 2. However, the clocks may be generated by a single clock generator. The clock generator outputs the clocks to both the first circuit 1 and the second circuit 2. In this case, it is not necessary to provide the variable delay controller 213 in the clock generator. The delay controller 3 controls the VDLs 223 to 243 to adjust the clock phase difference between the first circuit 1 and the second circuit 2.

As described above, the transmission apparatus according to the present embodiment obtains the phase difference of the reference clocks at the points after the reference clocks passing through each of the data processor units of the first circuit and the second circuit. The transmission apparatus adjusts the phase difference of the reference clocks between the first circuit and the second circuit in the entire transmission apparatus through the phase adjustment of the reference clocks of one of the first and second circuit at each point using the obtained phase difference. With this configuration, an accurate phase adjustment of the reference clocks can be achieved at any point in the first circuit and the second circuit which are the data transmission paths. It is therefore possible to continuously transmit the data without any suspension of the service in the event of a switchover from the first circuit to the second circuit.

### Second Embodiment

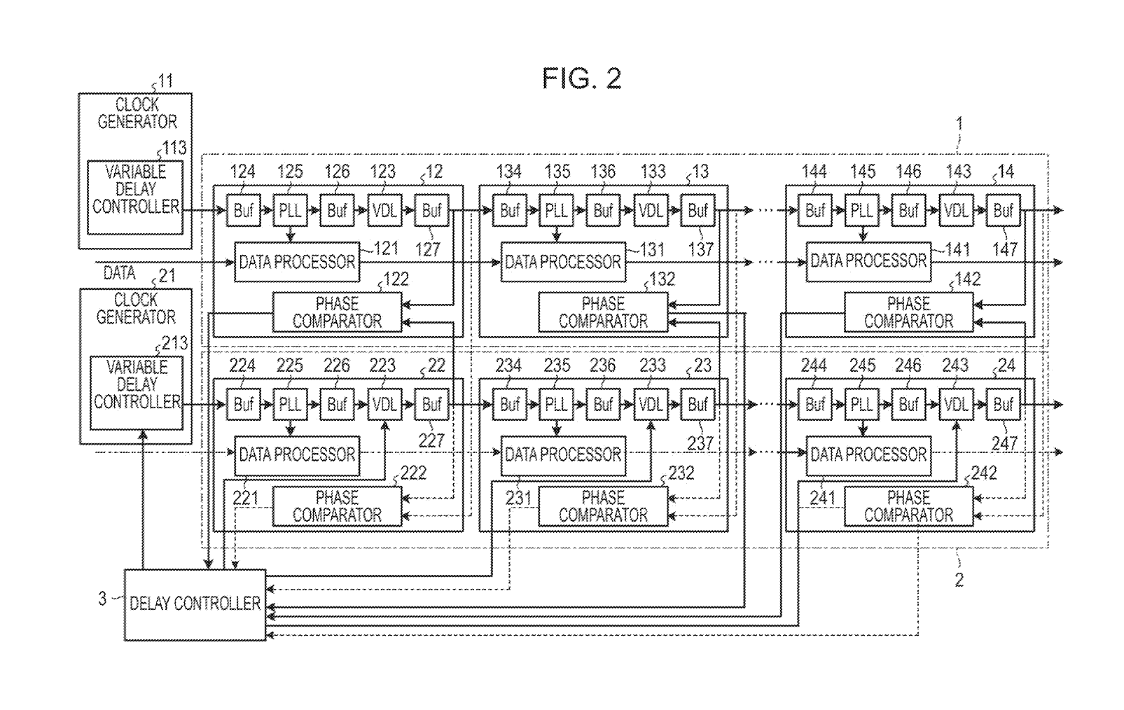

FIG. 2 is a block diagram of a transmission apparatus according to a second embodiment. The transmission apparatus according to the second embodiment includes a first circuit 1 and a second circuit 2 as data transmission paths. For example, the first circuit 1 is a working circuit and the second circuit 2 is a protection circuit. In the following description, the first circuit 1 is referred to as the working circuit and the second circuit 2 is referred to as the protection circuit. Hereinafter, the first circuit 1 may be referred to as a “working circuit 1” and the second circuit 2 may be referred to as a “protection circuit 2.” In the present embodiment, the transmission apparatus transmits data over the working circuit 1 upon startup. If the event of a failure in the working circuit 1, the data transmission path is switched to the protection circuit 2 to continue the data transmission.

The transmission apparatus includes a clock generator 11 which outputs reference clocks to the working circuit 1 and a clock generator 21 which outputs clocks to a protection circuit 2.

The clock generator 11 includes a variable delay controller 113. The clock generator 11 generates first reference clocks. The variable delay controller 113 outputs the clocks generated by the clock generator 11 to the data processor unit 12 with no delay provided. This is because the first circuit 1 is used as the working circuit in the present embodiment and thus the clock adjustment is performed in the protection circuit. If the first circuit 1 is the protection circuit, for example, the variable delay controller 113 executes the operation similar to that of a variable delay controller 213 which will be described later.

The working circuit 1 includes data processor units 12 to 14. The data processor unit 12 includes a data processor 121, a phase comparator 122, a VDL 123, a buffer (Buf) 124, a phase-locked loop (PLL) 125, a Buf 126 and a Buf 127.

The Buf 124 receives the first reference clocks from the variable delay controller 113. The Buf 124 eliminates the influence of an input impedance for the first reference clocks. The Buf 124 outputs the first reference clocks to the PLL 125.

The PLL 125 receives the first reference clocks from the Buf 124. The PLL 125 makes the frequencies of the first reference clocks and the signals to be processed in the data processor 121 to be synchronized with each other. The PLL 125 outputs the first reference clocks to the Buf 126.

The Buf 126 receives the first reference clocks from the PLL 125. The Buf 126 eliminates the influence of the input impedance for the first reference clocks. The Buf 126 outputs the first reference clocks to the VDL 123.

The VDL 123 receives the first reference clocks from the Buf 126. The VDL 123 outputs the first reference clocks to the Buf 127 with no delay (i.e., a phase difference) provided. This is because the first circuit 1 is used as the working circuit in the present embodiment and thus the clock adjustment is performed in the protection circuit. If the first circuit 1 is the protection circuit, for example, the VDL 123 executes the operation similar to that of a VDL 223 which will be described later.

The Buf 127 receives the first reference clocks from the VDL 123. The Buf 127 eliminates the influence of the input impedance for the first reference clocks. The Buf 127 outputs the first reference clocks to a data processor unit 13.

The data processor 121 receives data input from external devices, such as a mobile station and a server. The data processor 121 executes predetermined processing to the data using the first reference clocks received from the PLL 125. The data processor 121 outputs the data to the data processor 131 of the data processor unit 13.

The phase comparator 122 acquires the first reference clocks output from the Buf 127 of the working circuit 1. The phase comparator 122 acquires the second reference clocks output from the Buf 227 of the protection circuit 2. The phase comparator 122 compares the first reference clocks output from the Buf 127 with the second reference clocks output from the Buf 227. The phase comparator 122 obtains a phase difference between the first reference clocks output from the Buf 127 and the second reference clocks output from the Buf 227. The phase comparator 122 outputs, to the delay controller 3, the phase difference between the first reference clocks output from the Buf 127 and the second reference clocks output from the Buf 227.

In the present embodiment, the data processor unit 13 includes a data processor 131, a phase comparator 132, a VDL 133, a Buf 134, a PLL 135, a Buf 136 and a Buf 137. The data processor unit 14 includes a data processor 141, a phase comparator 142, a VDL 143, a Buf 144, a PLL 145, a Buf 146 and a Buf 147. The Bufs 134, 136, 137, 144, 146 and 147 eliminate the influence of the input impedance for the first reference clocks. The PLL 135 and the PLL 145 make the frequencies of the first reference clocks and the signals to be processed in the data processor units 131 and 141 to be synchronized with each other. The data processor units 131 and 141 execute predetermined processing to the received data and output the same. Since the first circuit 1 is the working circuit in the present embodiment, the VDLs 133 and 143 transmit the reference clocks without any processing.

The Buf 147 of the data processor unit 14 outputs the first reference clocks to external devices. The data processor 141 outputs the processed data to external devices.

It is also possible to use data processed in data processor units other than the data processor unit 14, e.g., the data processor units 12 and 13, in other devices. In that case, the data processor units 12 and 13 output the data to other devices together with the reference clocks.

The phase comparator 132 compares the first reference clocks output from the Buf 137 with the second reference clocks output from the Buf 237. The phase comparator 132 then outputs, to the delay controller 3, the phase difference between the first reference clocks output from the Buf 137 and the second reference clocks output from the Buf 237.

The phase comparator 142 compares the first reference clocks output from the Buf 147 with the second reference clocks output from the Buf 247. The phase comparator 142 then outputs, to the delay controller 3, the phase difference between the first reference clocks output from the Buf 147 and the second reference clocks output from the Buf 247.

The clock generator 21 includes a variable delay controller 213. The clock generator 21 produces the second reference clocks. When received control from the delay controller 3 to provide a delay (i.e., a phase difference), the variable delay controller 213 provides the second reference clocks with a delay (i.e., a phase difference) in an amount designated by the delay controller 3 and the second reference clocks are output to the data processor unit 22. The variable delay controller 213 is an exemplary output terminal phase adjuster.

The protection circuit 2 includes data processor units 22 to 24.

The data processor unit 22 includes a data processor 221, a phase comparator 222, a VDL 223, a Buf 224, a PLL 225, a Buf 226 and a Buf 227.

The Buf 224 receives the second reference clocks from the variable delay controller 213. The Buf 224 eliminates the influence of an input impedance for the second reference clocks. The Buf 224 outputs the second reference clocks to the PLL 225.

The PLL 225 receives the second reference clocks from the Buf 224. The PLL 225 makes the frequencies of the second reference clocks and the signals to be processed in the data processor 221 to be synchronized with each other. The PLL 225 outputs the second reference clocks to the Buf 226.

The Buf 226 receives the second reference clocks from the PLL 225. The Buf 226 eliminates the influence of the input impedance for the second reference clocks. The Buf 226 outputs the second reference clocks to the VDL 223.

The VDL 223 receives the first reference clocks from the Buf 226. The VDL 223 is controlled by the delay controller 3 to provide a delay (i.e., a phase difference) to the produced second reference clocks in an amount designated by the delay controller 3. The VDL 223 then outputs the second reference clocks to the Buf 227.

The Buf 227 receives the second reference clocks from the VDL 223. The Buf 227 eliminates the influence of the input impedance for the second reference clocks. The Buf 227 outputs the second reference clocks to a data processor unit 23.

The data processor 221 is kept on standby unless a failure occurs in the working circuit 1, since the second circuit 2 is the protection circuit. After a switchover of the circuits takes place, the data processor 221 receives data input from external devices, such as a mobile station and a server. The data processor 221 executes predetermined processes to the data using the second reference clocks received from the PLL 225. The data processor 221 outputs the data to the data processor 231 of the data processor unit 23. A two-dot chain lines in FIG. 2 represents a data flow after a switchover of the data transmission path to the second circuit 2 took place.

A calculation of the phase difference between the reference clocks in the data processor unit 12 and the reference clocks in the data processor unit 22 may be performed in either of the phase comparator 122 or the phase comparator 222. Thus, the phase comparator 222 does not operate in the present embodiment. Alternatively, however, the phase comparator 222, instead of the phase comparator 122, may be operated for the phase comparison. Dotted lines represent data flows in a case in which the phase comparator 222 compares the phases.

In the present embodiment, the data processor unit 23 includes a data processor 231, a phase comparator 232, a VDL 233, a Buf 234, a PLL 235, a Buf 236 and a Buf 237. The data processor unit 24 includes a data processor 241, a phase comparator 242, a VDL 243, a Buf 244, a PLL 245, a Buf 246 and a Buf 247. The Buf 234, 236, 237, 244, 246 and 247 eliminate the input impedances for the second reference clocks. When a switchover of the circuit takes place, the PLLs 235 and 245 make the frequencies of the second reference clocks and the signals to be processed in the data processor units 231 and 241 to be synchronized with each other. When a switchover of the circuit takes place, the data processor units 231 and 241 execute predetermined processing to the received data and output the data.

The VDL 233 is controlled by the delay controller 3 to provide a delay (i.e., a phase difference) to the second reference clocks in an amount designated by the delay controller 3.

The VDL 243 is controlled by the delay controller 3 to provide a delay (i.e., a phase difference) to the second reference clocks in an amount designated by the delay controller 3. Note that the second clocks output from the VDL 243 are supplied to external devices without being used for data processing. It is therefore not necessary to perform delay control in the VDL 243. Thus, the VDL 243 outputs the second reference clocks with no delay (i.e., a phase difference) provided in the present embodiment.

Since the phase comparators 132 and 142 compare the phases, the phase comparators 232 and 242 do not operate in the present embodiment. Alternatively, however, the phase comparators 232 and 242, instead of the phase comparators 132 and 142, may be operated for the phase comparison.

The delay controller 3 receives, from the phase comparator 122, data of the phase difference between the first reference clocks output from the Buf 127 and the second reference clocks output from the Buf 227. The delay controller 3 receives, from the phase comparator 132, data of the phase difference between the first reference clocks output from the Buf 137 and the second reference clocks output from the Buf 237. The delay controller 3 receives, from the phase comparator 142, data of the phase difference between the first reference clocks output from the Buf 147 and the second reference clocks output from the Buf 247.

The delay controller 3 obtains a delay (i.e., a phase difference) to be provided to the second reference clocks in each of the variable delay controller 213 and the VDLs 223 to 243 on the basis of each of the received phase differences. The method for obtaining the phase difference will be described in detail later. The delay controller 3 controls the variable delay controller 213 and the VDLs 223 to 243 to provide the second reference clocks with the obtained delay.

In the present embodiment, both the first circuit 1 and the second circuit 2 include the phase comparator and the VDL such that both the first circuit 1 and the second circuit 2 can be used for the phase adjustment. If the phase comparison is performed by one of the first circuit 1 and the second circuit 2, it is not necessary to provide the phase comparator in the other one. If the phase adjustment is performed by one of the first circuit 1 and the second circuit 2, it is not necessary to provide the phase comparator in the other one.

Although the data processor units 12 to 14 have the same configuration as illustrated in FIG. 1, they may have different configurations. Although the data processor units 22 to 24 have the same configuration, they may have different configurations. Even if the data processor units have different configurations, the transmission apparatus according to the present embodiment can be implemented.

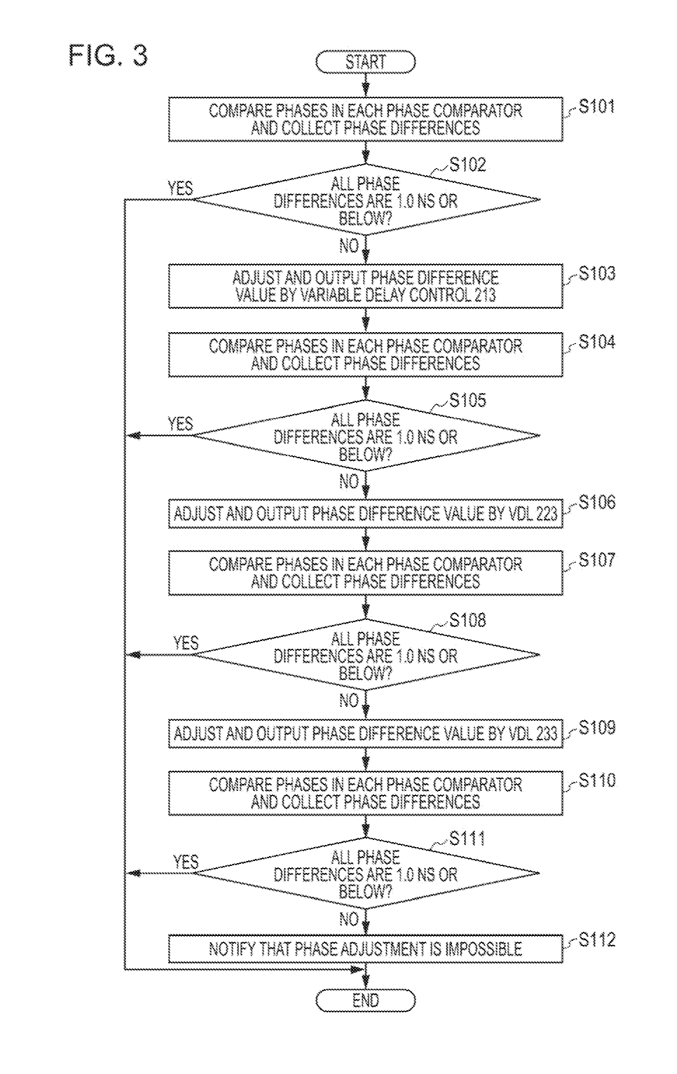

Here, an exemplary process of the phase adjustment by the delay controller 3 will be described with reference to FIG. 3. FIG. 3 is a flowchart of an exemplary process of the phase adjustment. For simplicity of illustration, it is assumed herein that the working circuit 1 includes only the data processor units 12 to 14 and that the protection circuit 2 includes only the data processor units 22 to 24. The process of the phase adjustment illustrated in FIG. 3 is a procedure in which the phase adjustment is performed beginning with a point that is closest to the clock output terminal and is set to have higher priority such that the phase difference is in the range of 1.0 ns.

The phase comparators 122, 132 1nd 142 each perform the phase comparison and obtain the phase difference between the first reference clocks and the second reference clocks therein. The delay controller 3 receives and collects data of the phase differences from the phase comparators 122 to 142 (step S101).

The delay controller 3 determines whether all the phase differences are 1.0 ns or below (step S102). If the determination result in step S102 is affirmative, the transmission apparatus completes the process of the phase adjustment.

If the determination result in step S102 is negative, the delay controller 3 controls the variable delay controller 213 to adjust the phase difference therein such that the phase difference in the phase comparator 122 becomes 1.0 ns or below. The clock generator 21 generates and outputs the clocks (step S103).

The phase comparators 122, 132 and 142 each perform the phase comparison and obtain the phase difference between the first reference clocks and the second reference clocks therein. The delay controller 3 receives and collects data of the phase differences from the phase comparators 122, 132 and 142 (step S104).

The delay controller 3 determines whether all the phase differences are 1.0 ns or below (step S105). If the determination result in step S105 is affirmative, the transmission apparatus completes the process of the phase adjustment.

If the determination result in step S105 is negative, The delay controller 3 controls the VDL 223 to adjust the phase difference therein such that the phase difference in the phase comparator 132 becomes 1.0 ns or below. The clock generator 21 generates and outputs the clocks (step S106).

The phase comparators 122, 132 and 142 each perform the phase comparison and obtain the phase difference between the first reference clocks and the second reference clocks therein. The delay controller 3 receives and collects data of the phase differences from the phase comparators 122, 132 and 142 (step S107).

The delay controller 3 determines whether all the phase differences are 1.0 ns or below (step S108). If the determination result in step S108 is affirmative, the transmission apparatus completes the process of the phase adjustment.

If the determination result in step S108 is negative, The delay controller 3 controls the VDL 233 to adjust the phase difference therein such that the phase difference in the phase comparator 142 becomes 1.0 ns or below. The clock generator 21 generates and outputs the clocks (step S109).

The phase comparators 122, 132 and 142 each perform the phase comparison and obtain the phase difference between the first reference clocks and the second reference clocks therein. The delay controller 3 receives and collects data of the phase differences from the phase comparators 122, 132 and 142 (step S110).

The delay controller 3 determines whether all the phase differences are 1.0 ns or below (step S111). If the determination result in step S111 is affirmative, the transmission apparatus completes the process of the phase adjustment.

If the determination result in step S111 is negative, the transmission apparatus notifies the operator that the phase adjustment is impossible (step S112).

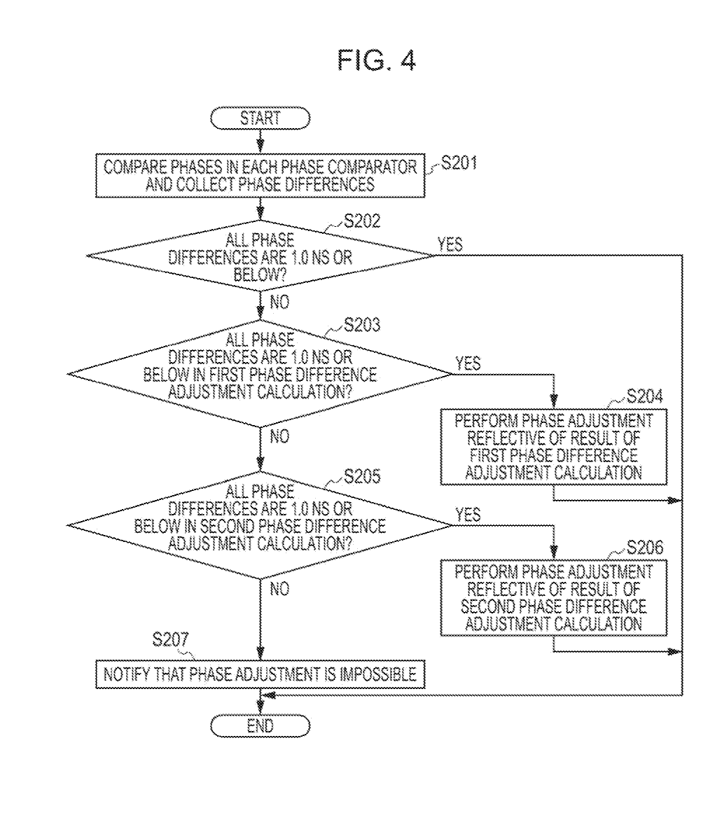

Next, another exemplary process of the phase adjustment by the delay controller 3 will be described with reference to FIG. 4. FIG. 4 is a flowchart of another exemplary phase adjustment process. For simplicity of illustration, it is assumed that the working circuit 1 includes only the data processor units 12, 13 and 14 and that the protection circuit 2 includes only the data processor units 22, 23 and 24. In this example, it is assumed that a procedure for a first phase adjustment calculation and a procedure for a second phase adjustment calculation are previously stored in the delay controller 3. The first phase adjustment calculation is performed to calculate an average value of the phase differences obtained by the phase comparators, and calculate the phase difference in each phase comparator when the phase adjustment based on the calculated average value is performed in the variable delay controller 213. The second phase adjustment calculation is performed to specify the data processor unit which includes the phase comparator with the phase difference of X ns (X>=1), and then calculate the phase difference in each of the phase comparator at the time of performing the phase adjustment to be the phase difference of (X−1.0) ns at the variable delay controller 213 or the VDL disposed in the data processor unit immediately before the specified data processor unit. The process illustrated in FIG. 4 is a procedure for performing the phase adjustment using the average of all the obtained phase differences at the clock output terminal (i.e., the variable delay controller 213) and the phase adjustment is performed at places where all the phase differences are still not in the range of 1.0 ns.

In each of the phase comparators, the phases of the first reference clocks and the second reference clocks are compared to obtain the phase difference between the first reference clocks and the second reference clocks. The delay controller 3 receives and collects data of the phase differences (step S201).

The delay controller 3 determines whether all the phase differences are 1.0 ns or below (step S202). If the determination result in step S202 is affirmative, the transmission apparatus completes the process of the phase adjustment.

If the determination result in step S202 is negative, the delay controller 3 performs the first phase adjustment calculation and then determines whether all the phase differences obtained in the calculation are 1.0 ns or below (step S203). If the determination result in step S203 is affirmative, the transmission apparatus performs the phase adjustment which is reflective of the result of the first phase adjustment calculation (step S204).

If the determination result in step S203 is negative, the delay controller 3 performs the second phase adjustment calculation and then determines whether all the phase differences obtained in the calculation are 1.0 ns or below (step S205). If the determination result in step S205 is affirmative, the transmission apparatus performs the phase adjustment which is reflective of the result of the first phase adjustment calculation (step S206).

If the determination result in step S205 is negative, the transmission apparatus notifies the operator that the phase adjustment is impossible (step S207).

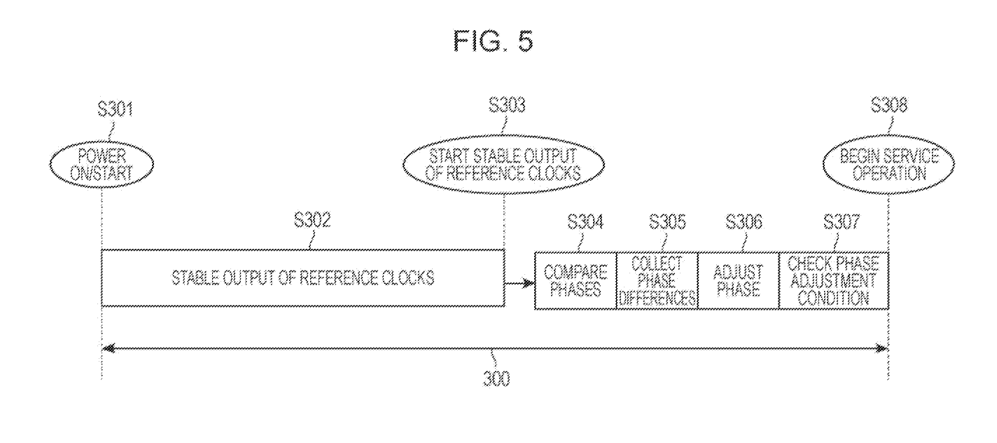

Next, the time required for the phase adjustment in the transmission apparatus according to the second embodiment will be described. FIG. 5 is a timing diagram of a phase adjustment process in the transmission apparatus according to the second embodiment.

As illustrated in FIG. 5, the transmission apparatus is first powered on and the processing of the transmission apparatus is started (step S301). A stable output process of the reference clocks is started in the clock generator (step S302). Upon completion of the stable output process of the reference clocks (step S302), a stable output of the reference clocks is started (step S303). When the reference clocks are input to each of the phase comparators, the phase comparison of the reference clocks will be performed in each phase comparator (step S304). Next, the delay controller 3 collects data of the phase differences (step S305). The delay controller 3 then performs the phase adjustment (step S306). The delay controller 3 checks the phase adjustment condition (step S307). If the phase adjustment condition is good, the service operation is started (step S308). This means that, in the transmission apparatus according to the second embodiment, time 300 is required since the powering-on/startup (step S301) before the service operation start (step S308).

Although two phase adjustment methods have been described, other methods may alternatively be employed. Preferably, the phase adjustment method is determined in consideration of conditions of adjustment methods, such as whether to perform the phase adjustment using the average value of all the phase differences, the system configuration, requests for the operation and priority.

As described above, the transmission apparatus according to the present embodiment obtains the phase difference of the reference clocks between the working circuit and the protection circuit at each point through which the reference clocks are transmitted within the device. In operation, the transmission apparatus performs the phase adjustment at each point using the obtained phase difference such that the phase difference of the reference clocks between the working circuit and the protection circuit becomes smaller than a predetermined value at any points of the transmission path of the reference clocks. With this configuration, the phase adjustment of the reference clocks of the working circuit and the protection circuit can be performed accurately at any points of the data transmission path. It is therefore possible to continue data transmission without suspension of the service in the event that the data transmission path switches from the working circuit to the protection circuit.

### Third Embodiment

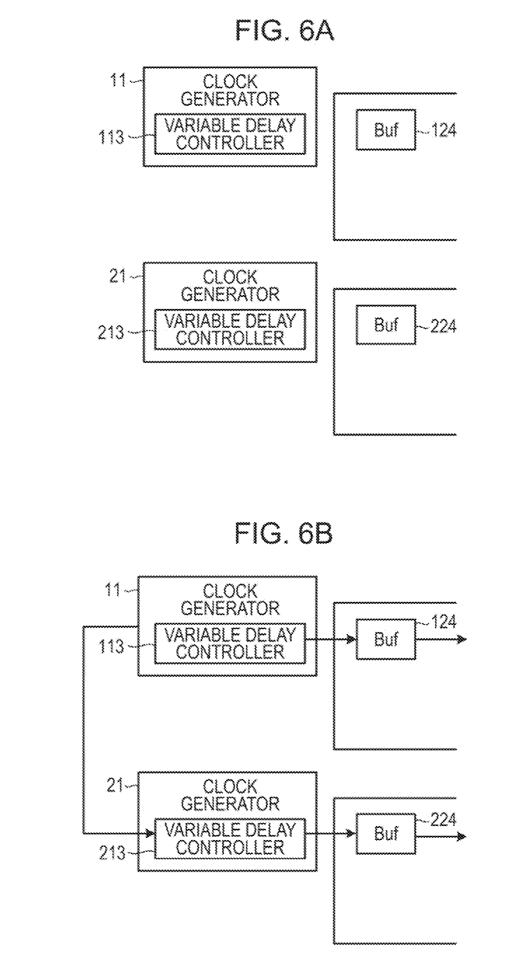

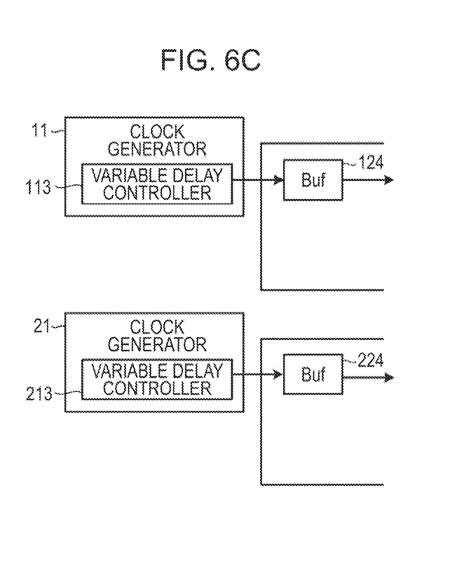

The transmission apparatus according to a third embodiment is similar to that of the second embodiment except for the phase adjustment using reference clocks of either the first circuit or the second circuit. Accordingly, an output of the reference clocks will be described mainly. FIG. 6A illustrates a state upon startup of an transmission apparatus. FIG. 6B illustrates a state before stabilization of an oscillator frequency of the transmission apparatus. FIG. 6C illustrates a state after the stabilization of the clock frequency and the phase adjustment of the transmission apparatus. In the present embodiment, the first circuit 1 is referred to as the working circuit and the second circuit 2 is referred to as the protection circuit. Hereinafter, the first circuit 1 may be referred to as a “working circuit 1” and the second circuit 2 may be referred to as a “protection circuit 2.”

In the following description, a phase shift between the reference clocks in the working circuit 1 and the reference clocks in the protection circuit 2 will be adjusted using the first reference clocks output from the clock generator 11 disposed in the working circuit 1.

The transmission apparatus requires the reference clocks with highly accurate frequency to achieve accurate data transmission. Thus, highly reliable components are used in the clock generator 11. If highly reliable components are used, the reference clocks are sometimes not be output after the powering-on of the power supply before a predetermined time elapses. It is assumed in the present embodiment that, for example, highly reliable components which do not output the reference clocks since the powering-on of the power supply before a predetermined time elapses are used in the clock generator 11. Thus, the clock generator 11 does not output the first reference clocks until a predetermined time elapses. The clock generator 11 does not output the first reference clocks to the Buf 124 as illustrated in FIG. 6A immediately upon powering-on and startup of the transmission apparatus. This also applies to the clock generator 21.

When a predetermined time elapses, the clock generator 11 outputs the first reference clocks to the Buf 124 of the working circuit 1 via the variable delay controller 113 as illustrated in FIG. 6B. The clock generator 11 outputs the first reference clocks to the Buf 224 of the protection circuit 2 via the variable delay controller 213. At this time, the reference clocks from the clock generator 11 are not stabilized yet. That is, the clock generator 11 has not output the reference clocks with which the service operation can be started yet.

In the present embodiment, the reference clocks are output from the clock generator 11 via the variable delay controller 213 to perform the phase adjustment in the variable delay controller 213. However, if the phase adjustment is not performed by the variable delay controller 213, the first reference clocks may be output from the clock generator 11 to the Buf 224 of the protection circuit 2.

The phase comparator 122, as described in FIG. 2, compares the first reference clocks output from the Buf 127 of the working circuit 1 with the first reference clocks output from the Buf 227 of the protection circuit 2. The phase comparator 122 obtains the phase difference between the first reference clocks output from the Buf 127 and the first reference clocks output from the Buf 227.

Similarly, as described in FIG. 2, the phase comparator 132 obtains the phase difference between the first reference clocks output from the Buf 137 and the first reference clocks output from the Buf 237. The phase comparator 142 obtains the phase difference between the first reference clocks output from the Buf 147 and the first reference clocks output from the Buf 247.

The delay controller 3 obtains a delay (i.e., a phase difference) to be provided to the variable delay controller 213 and the VDLs 223 to 243 on the basis of the phase difference obtained by the phase comparators 122 to 142. The delay is obtained by, for example the same manner as in the second embodiment. The delay controller 3 controls the variable delay controller 213 and the VDLs 223 to 243 to provide the obtained delay (i.e., a phase difference).

When the phase adjustment of the reference clocks is completed and the outputs from the clock generator 11 and the clock generator 21 are stabilized, to achieve the state illustrated in FIG. 6C is taken. That is, the clock generator 11 outputs the first reference clocks to the Buf 124 via the variable delay controller 113. The clock generator 21 outputs the second reference clocks to the Buf 224 via the variable delay controller 213.

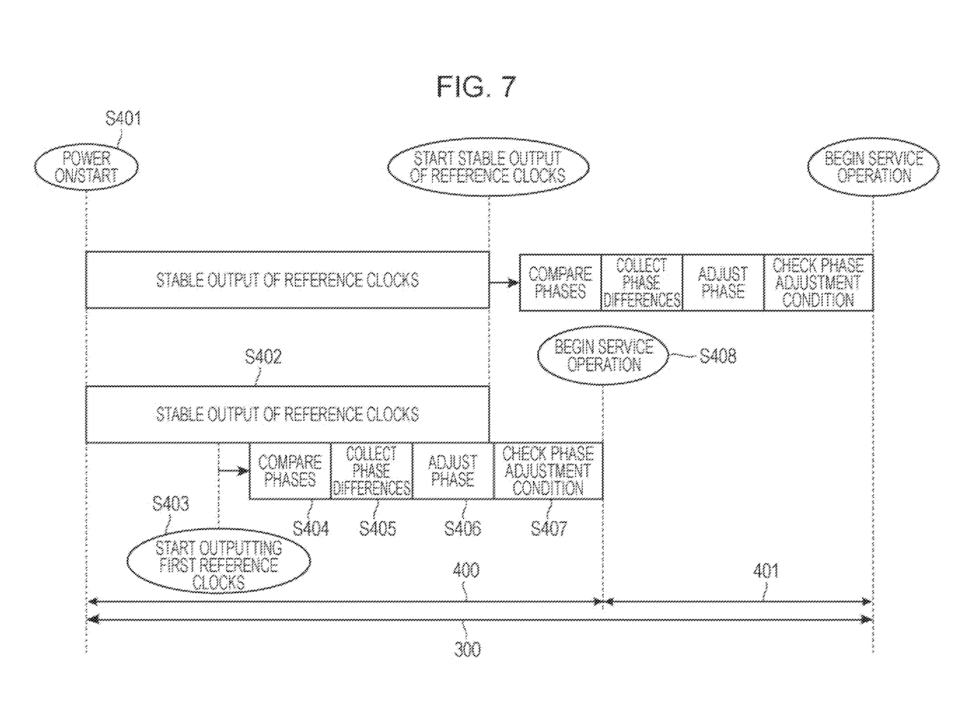

Next, the time required for the phase adjustment in the transmission apparatus according to the present embodiment will be described. FIG. 7 is a timing diagram used for the comparison of time required for the phase adjustment in the second embodiment.

In the transmission apparatus according to the present embodiment, the transmission apparatus is powered on first and is started (step S401). The stable output process of the reference clocks is started in the clock generator 11 and the clock generator 21 (step S402).

The phase adjustment is performed using the first reference clocks in both the working circuit 1 and the protection circuit 2 in the present embodiment. It suffices that the first reference clocks are output and thus not necessary stabilized. This is because the phase shift can be obtained if the same clock is used though the clocks are not stabilized. While the stable output process (step S402) of the reference clocks is performed, the clock generator 11 starts outputting the first reference clocks (step S403).

When the first reference clocks in the working circuit 1 and the first reference clocks in the protection circuit 2 are input to the phase comparators 122 to 124, the phase comparators 122 to 124 each perform the phase comparison (step S404).

The delay controller 3 collects data of the phase differences from the phase comparators 122 to 124 (step S405).

Next, the delay controller 3 controls the variable delay controller 213 and the VDL 223 to 243 to perform the phase adjustment (step S406).

The delay controller 3 checks the phase adjustment condition (step S407).

If the phase adjustment condition is good, the service operation is started (step S408). Step S407 is completed after step S402 is completed in the present embodiment; step S407 may be completed before step S402 is completed in such a case where the stable output process of the reference clocks takes longer time. In such a case, since the phase adjustment is already completed, the service operation (step S408) is started upon completion of the stable output process of the reference clocks (step S402).

Thus, in the transmission apparatus according to the present embodiment, the time required since the powering-on/startup (step S401) before the start of the service operation (step S408) is time 400. A comparison between the time 400 and the time 300 which is required since the powering-on/startup before the start of the service operation in the second embodiment shows that the time is shortened by time 401 as illustrated in FIG. 7.

As described above, the transmission apparatus according to the present embodiment can start the phase adjustment without waiting for the stable output of the reference clocks. It is therefore possible to perform the accurate phase adjustment of the reference clocks of the working circuit and the reference clocks of the protection circuit at any point on the data transmission path while shortening the time since the powering-on/startup before the start of the service operation.

### Fourth Embodiment

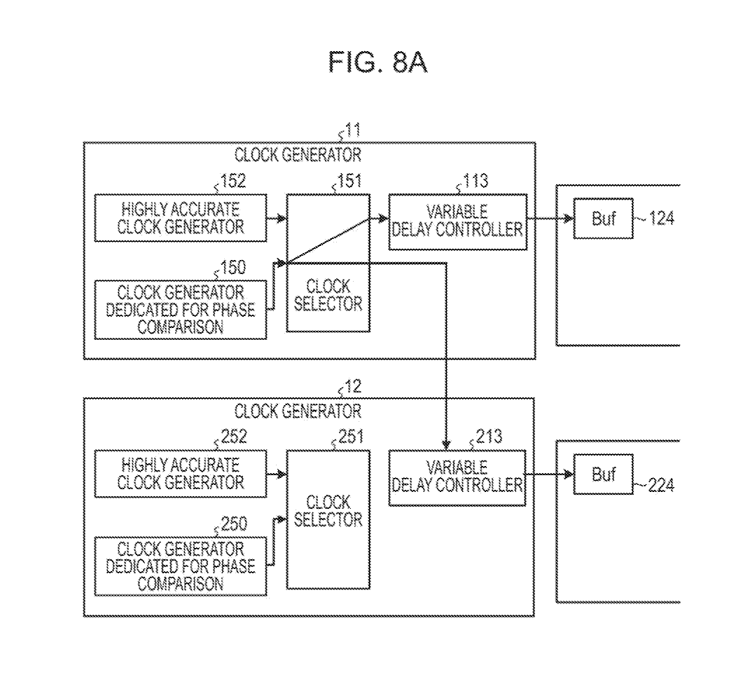

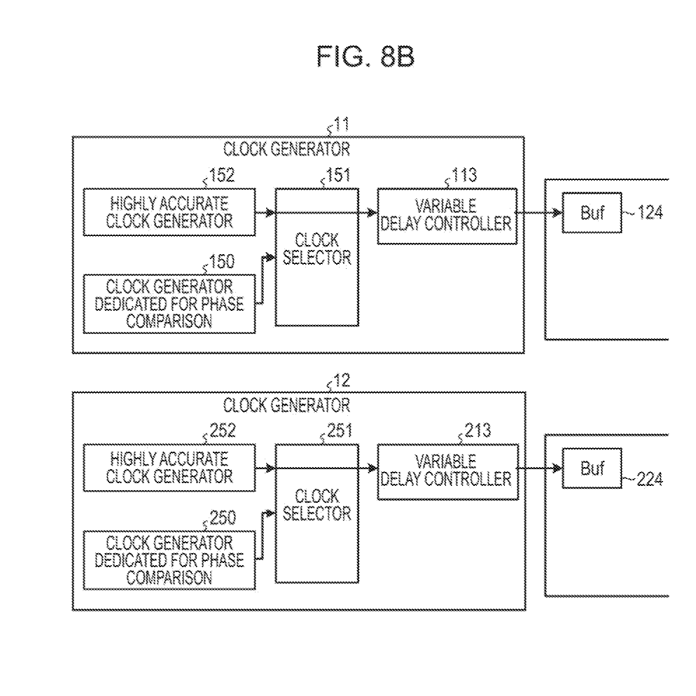

The transmission apparatus according to a fourth embodiment is similar to that of the second embodiment except for the phase adjustment using clocks dedicated for phase comparison disposed in the first circuit. Accordingly, an output of the reference clocks will be described mainly. FIG. 8A illustrates a state upon startup of a transmission apparatus. FIG. 8B illustrates a state after the stabilization of the clock frequency and the phase adjustment of the transmission apparatus. In the present embodiment, the first circuit 1 is referred to as the working circuit and the second circuit 2 is referred to as the protection circuit. Hereinafter, the first circuit 1 may be referred to as a “working circuit 1” and the second circuit 2 may be referred to as a “protection circuit 2.”

In the following description, a phase shift between the reference clocks in the working circuit 1 and the reference clocks in the protection circuit 2 will be adjusted using the first reference clocks output from the clock generator dedicated for phase comparison 150 disposed in the working circuit 1.

The clock generator 11 includes a variable delay controller 113, a clock generator dedicated for phase comparison 150, a clock selector 151 and a highly accurate clock generator 152.

The highly accurate clock generator 152 produces highly accurate clocks which are the same as the first reference clocks in the first to third embodiments. Reliable components are used in the highly accurate clock generator 152 which produces clocks to be used for actual data transmission. Accordingly, the highly accurate clock generator 152 requires a predetermined time until the output of the clocks is started.

In the clock generator dedicated for the phase comparison 150, components with reliability that is not high enough for the highly accurate clock generator 152 are used. Thus, the clock generator dedicated for the phase comparison 150 outputs clocks immediately upon powering-on and startup of the transmission apparatus.

The clock selector 151 causes the reference clocks output from the highly accurate clock generator 152 and the clocks output from the clock generator dedicated for the phase comparison 150 to be selectively passed. As illustrated in FIG. 8A, the clock selector 151 causes the clocks output from the clock generator dedicated for the phase comparison 150 to be passed and outputs the clocks to the variable delay controller 113 and the variable delay controller 213 since the powering-on and startup of the transmission apparatus before the phase adjustment is completed.

When the phase adjustment is completed and the output of the highly accurate clock generator 152 is stabilized, as illustrated in FIG. 8B, the clock selector 151 causes the reference clocks output from the highly accurate clock generator 152 to be passed and output to the variable delay controller 113.

In the present embodiment, the reference clocks are output from the clock generator 11 via the variable delay controller 213 to perform the phase adjustment in the variable delay controller 213. However, if the phase adjustment is not performed by the variable delay controller 213, the first reference clocks may be output from the clock generator 11 to the Buf 224 of the protection circuit 2.

The phase comparator 122, as described in FIG. 2, compares the reference clocks output from the Buf 127 of the working circuit 1 with the reference clocks output from the Buf 227 of the protection circuit 2. The phase comparator 122 obtains the phase difference between the reference clocks output from the Buf 127 and the reference clocks output from the Buf 227.

Similarly, as described in FIG. 2, the phase comparator 132 obtains the phase difference between the reference clocks output from the Buf 137 and the reference clocks output from the Buf 237. The phase comparator 142 obtains the phase difference between the reference clocks output from the Buf 147 and the reference clocks output from the Buf 247.

The delay controller 3 obtains a delay (i.e., a phase difference) to be provided to the variable delay controller 213 and the VDLs 223 to 243 on the basis of the phase difference obtained by the phase comparators 122 to 142. The delay is obtained by, for example the same manner as in the second embodiment. The delay controller 3 controls the variable delay controller 213 and the VDLs 223 to 243 to provide the obtained delay (i.e., a phase difference).

When the phase adjustment of the reference clocks is completed and the outputs from the clock generator 11 and the clock generator 21 are stabilized, to achieve the state illustrated in FIG. 8B is taken. That is, the first reference clocks output from the highly accurate clock generator 152 are output to the Buf 124 via the variable delay controller 113. The second reference clocks output from the highly accurate clock generator 252 are output to the Buf 224 via the variable delay controller 213.

Since the clock generator dedicated for the phase comparison 150 of the working circuit 1 is used in the present embodiment, the clocks output from the clock generator dedicated for the phase comparison 250 are not used. The clock selector 251 may cause only the second reference clocks output from the highly accurate clock generator 252 to be always passed. If, however, the phase adjustment is performed using the clock generator dedicated for the phase comparison 250 of the second circuit 2, the clock selector 251 operates in a manner similar to that of the clock selector 151 in the present embodiment.

In the present embodiment, both the first circuit 1 and the second circuit 2 include the clock generator dedicated for the phase comparison and the clock selector such that both the first circuit 1 and the second circuit 2 can be used for the phase adjustment. If the phase comparison is performed by one of the first circuit 1 and the second circuit 2, it is not necessary to provide the clock generator dedicated for the phase comparison and the clock selector in the other one.

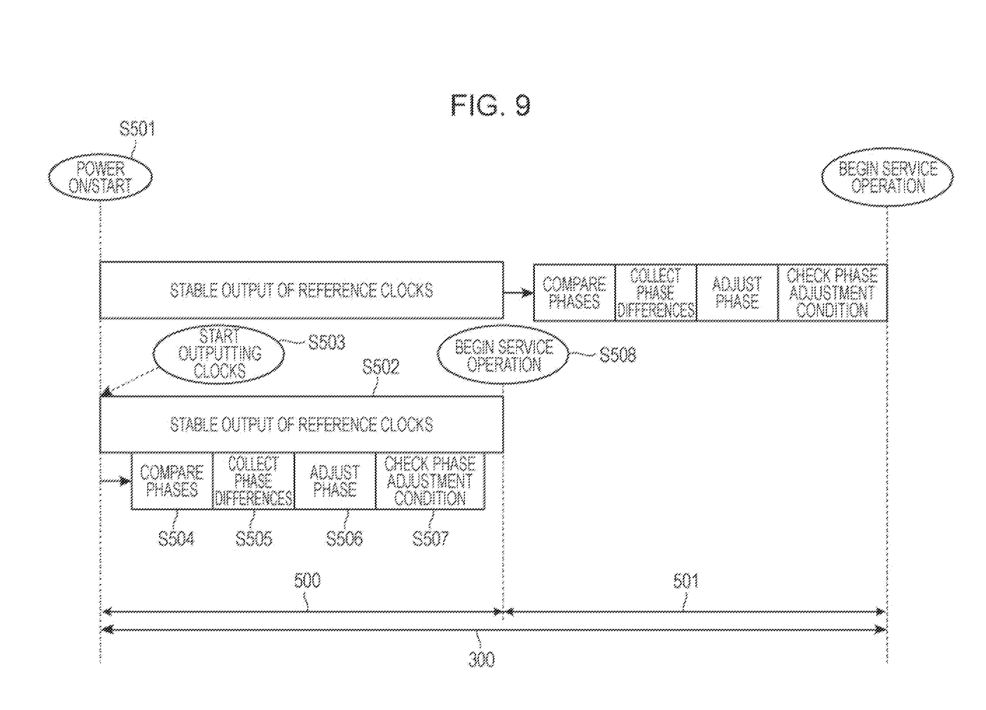

Next, the time required for the phase adjustment in the transmission apparatus according to the present embodiment will be described. FIG. 9 is a timing diagram used for the comparison of time required for the phase adjustment in the second embodiment.

In the transmission apparatus according to the present embodiment, the transmission apparatus is powered on first and is started (step S501). The stable output process of the reference clocks is started in the clock generator 11 and the clock generator 21 (step S502).

In the present embodiment, the clock generator dedicated for the phase comparison 250 starts outputting the clocks immediately upon powering-on/startup (step S501) (step S503). Note that clocks with highly accurate frequency are not necessary for the phase comparison. This is because the clock phase difference can be obtained if the same waveform is used though the clocks are not stabilized.

When the clocks in the working circuit 1 and the clocks in the protection circuit 2 are input to the phase comparators 122 to 142, the phase comparators 122 to 142 each perform the phase comparison (step S504).

The delay controller 3 collects data of the phase differences from the phase comparators 122 to 142 (step S505).

Next, the delay controller 3 controls the variable delay controller 213 and the VDLs 223 to 243 to perform the phase adjustment (step S506).

The delay controller 3 checks a phase adjustment condition (step S507).

Since the phase adjustment is already completed, the service operation is started (step S508) upon completion of the stable output process (step S502) of the reference clocks.

Thus, in the transmission apparatus according to the present embodiment, the time required since the powering-on/startup (step S501) before the start of the service operation (step S508) is time 500. A comparison between the time 500 and the time 300 which is required since the powering-on/startup before the start of the service operation in the second embodiment shows that the time is shortened by time 501 as illustrated in FIG. 9. In comparison with the third embodiment, a predetermined time elapses until the clocks are output from the clock generator 11 in the third embodiment. In the present embodiment, however, the clocks are output immediately upon powering-on. Accordingly, also in comparison with the third embodiment, the time is shortened by the predetermined time in the transmission apparatus according to the present embodiment.

As described above, the clocks are output immediately upon powering-on and the phase adjustment can be started in the transmission apparatus according to the present embodiment. It is therefore possible to perform the accurate phase adjustment of the reference clocks of the working circuit and the reference clocks of the protection circuit at any point on the data transmission path while shortening the time since the powering-on/startup before the start of the service operation.

In the embodiments described above, the clock generator 11 outputs the clocks only to the first circuit 1 and the clock generator 21 outputs the clocks only to the second circuit 2 during the data transmission. However, in order to improve redundancy, both the clock generator 11 and the clock generator 21 may output the reference clocks to both the circuits.

Although the data processor units are disposed collectively at one place in the embodiments described above, the data processor units may alternatively be disposed at separated places as long as they are in a network connection.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A transmission apparatus comprising:
a clock generator to generate clocks;
a first circuit including a plurality of first data processors to process input data based on a first input clock, the plurality of first data processors electrically connected in series each transmitting data processed thereby and the first input clock to the next first data processor, the first input clock of the beginning first data processor being one of the clocks generated by the clock generator;
a second circuit including:
a plurality of second data processors to process input data based on a second input clock, the plurality of second data processors electrically connected in series each transmitting data processed thereby to the next second data processor, the second input clock of the beginning second data processor being one of the clocks generated by the clock generator; and
a plurality of phase adjusters each to adjust a phase of the second input clock and transmitting the second input clock adjusted thereby to the next second data processor;
a plurality of phase comparators each to compare phases of the first input clock transmitted from the first data processor and the second input clock transmitted from the phase adjuster; and
a delay controller to control the plurality of phase adjusters, based on comparison results of the plurality of phase comparators.

2. The transmission apparatus according to claim 1, wherein numbers of the first data processors, the second data processors, the phase adjusters and the phase comparators are same.

3. The transmission apparatus according to claim 1,
wherein the clock generator includes:
a first clock generator for generating the first input clock and transmitting the first input clock to the beginning first data processor; and
a second clock generator for generating the second input clock and transmitting the second input clock to the beginning second data processor, the second clock generator including a variable delay controller for adjusting a phase of the second input clock,
wherein the delay controller also controls the variable delay controller, based on comparison results of the plurality of phase comparators.

4. The transmission apparatus according to claim 3,
wherein the plurality of phase comparators derive phase differences from the comparison results, respectively, and
wherein the delay controller controls the variable delay controller and the plurality of phase adjusters so that the phase difference becomes to be equal to or smaller than a predetermined value.

5. The transmission apparatus according to claim 4, wherein the delay controller controls the variable delay controller and the plurality of phase adjusters in order of transmitting one of the first input clock and the second input clock.

6. The transmission apparatus according to claim 4, wherein the delay controller includes a storage medium in which data for indicating calculation procedures are stored, the calculation procedures being used for calculating an amount of adjusting the phase of the second input clock in the phase adjusters, based on phase differences obtained by the phase comparators.

7. The transmission apparatus according to claim 1, wherein the first circuit is used for a working circuit and the second circuit is used for a protection circuit, when the first circuit has a failure, the second circuit processes the input data based on the second input clock.

8. The transmission apparatus according to claim 1, wherein the clock generator generates one clock for the first input clock and the second input clock or generates one clock for the first input clock and another clock for the second input clock.

9. The transmission apparatus according to claim 1, wherein the clock generator includes:
a third clock generator for generating a third input clock with the transmission apparatus start-up; and
a fourth clock generator for generating a fourth input clock with highly accurate frequency,
wherein the clock generator transmits the third input clock and transmits the fourth input clock after transmitting the third input clock, to the first circuit and the second circuit.

10. A control method of a transmission apparatus comprising:
transmitting a first clock to a first circuit and a second clock to a second circuit;
transferring the first clock through a plurality of first data processors in the first circuit;
transferring the second clock through a plurality of second data processors in the second circuit;
comparing each of phases of the first clocks in the first data processors and phases of the second clocks in the second data processors; and
controlling phases of the second clocks of the second data processors, based on comparison results.
